(19) United States
(12) Patent Application Publication
(10) Pub. No.: US 2009/0035108 A1
(43) Pub. Date: Feb. 5, 2009

(54) Quick release apparatus for a spare tire

(76) Inventor: Jack Warner, Sunrise, FL (US)

Correspondence Address: THE INVENTORS NETWORK, INC., 332 ACADEMY STREET, CARNEGIE, PA, 15106, US

(21) Appl. No.: 11/881,983

(22) Filed: Jul. 31, 2007

(51) Int. Cl. B62D 43/04

(52) U.S. Cl. 414/463; 224/42.23

(57) ABSTRACT

A quick release apparatus mounted on or within the rear bumper of an automotive vehicle for releasing a spare tire located behind the rear wheels and subjacent the undercarriage includes a winch assembly that includes a drum housing a cable coiled upon a rotatable spoke extending through drum with the spare tire resting on and supported by a crossbar and the distal cable end extending through the center of the tire for attachment to the crossbar with the winch assembly also including a pivotal handle having a winch key and a release button so that setting the winch key disengages a ratchet mechanism mounted within the drum and interconnected to the spoke whereupon pressing the release button actuates the unwinding of the cable and the lowering of the spare tire.

### FIELD OF THE INVENTION

The present invention pertains to tire mounting and release assemblies, and more particularly pertains to an apparatus for raising and lowering exterior mounted spare tires.

### BACKGROUND OF THE INVENTION

One of the most dangerous, difficult, and unpleasant tasks involved in owning and/or driving an automotive vehicle of any kind (truck, pickup truck, SUV, minivan, passenger vehicle) is changing a tire, whether as part of routine maintenance or when one of the vehicle's tires has gone flat. This is a difficult and unpleasant task when it is performed on a vehicle located on a driveway or parking lot, and during daylight hours when the individual has the time and space to locate all the parts and pieces—jack, rod, handle, location, release, other tools, etc.—but changing a tire is transformed into a difficult, unpleasant, and, most significantly, dangerous task when the location is a narrow two-lane country road with little or no berm, or on the side of a busy expressway. The danger of changing a tire in such locations is increased when the breakdown occurs at night or during inclement weather (a heavy rainstorm or snow storm, etc.).

Moreover, with the number of single driver vehicles on the road, and especially the number of female drivers on the road at all times and in all driving conditions, having to change a tire becomes a dreaded and possibly life-threatening activity. Despite these factors the placement of spare tires, jacks, and jack handles in the majority of non-truck vehicles is still underneath a removable floor panel in the trunk of the vehicle. Thus, the spare tire must be lifted up and out of its recess within the floor panel and then placed at the appropriate location for changing. In addition, because of the strength and durability requirements, the various jack parts must be made from high-grade steel, and not of plastic, and thus the jack parts are heavy and bulky to use. As a result, a driver, and especially a female driver, is confronted with a number of difficulties involved in removal of the spare tire and location of all the parts and pieces, before even undertaking the demanding physical process of removing the damaged tire and replacing it with the spare tire. In view of these onerous difficulties the prior art discloses a range of devices and assemblies to facilitate the mounting and, when required, the releasing of a spare tire for automotive vehicles.

For example, the Ludwig patent (U.S. Pat. No. 4,060,171) discloses a quick catch and release clamp that includes a support post interconnected to a clamp means by a toggle post with the clamp means for clamping onto the vehicle frame and a supporting brace for supporting the tire.

The Morrison, Jr. patent (U.S. Pat. No. 4,161,267) discloses a trunk mount spare wheel carrier device that includes a base, a receiver upwardly extending therefrom, adjustable straps that interconnect the base to the trunk lid, and a threaded rod and yoke for adjusting strap tension for removing the carrier device from the trunk lid.

The Haves patent (U.S. Pat. No. 4,262,830) discloses a latch mechanism for releasably locking a hinged ornamental spare tire cover for vehicles into position on the rear bumper of a vehicle.

The Weaver patent (U.S. Pat. No. 5,002,452) discloses a quick release spare tire carrier that includes a support bar pivotally mounted to the rear trunk bumper by a pivot pin that upon release allows the bar to pivot so that the tire can be slidingly released from the support bar.

The Steelman patent (U.S. Pat. No. 5,370,285) discloses a quick release spare tire rack that includes a swing-away rack mounted to the rear bumper with the rack including a vertical support member to which the tire is mounted with the vertical support member being pivotally mounted to a hinge so that the vertical support member and the tire can be swung away from the rear of the vehicle.

The Young patent (U.S. Pat. No. 6,059,155) discloses a spare tire mounting assembly that includes a mounting plate mounted to the bumper of the vehicle, a post extending upwardly therefrom, and a channel slot formed at the upper end of the post for receiving a tire-mounting rod on which the tire is mounted.

Nonetheless, despite the ingenuity of the above mechanisms and devices, there remains a need for an assembly or mechanism that can quickly and easily release a tire when needed with a minimum of effort.

### SUMMARY OF THE INVENTION

The present invention comprehends a mechanism or device for mounting on or within a portion of the bumper of an automotive vehicle, such as a passenger vehicle, an SUV, a minivan, a pickup truck, or a commercial transport truck, and which connects to a spare tire for automatically releasing the spare tire.

The quick release device or apparatus includes a winch assembly mounted to or within a portion of the rear bumper of the vehicle. The winch assembly includes a drum and extending within and through the drum is a rotatable spoke. A cable is wound and coiled onto the spoke. Extending laterally from the drum is a cable tube, and a portion of the cable extends through the cable tube for securement to the spare tire. The spare tire is generally located behind the rear axle and between the rear wheels, and also subjacent the undercarriage to minimize movement—swinging and swaying—of the spare tire when the vehicle is in motion. Secured to the distal end of the cable is a crossbar with the spare tire resting upon and being supported by the crossbar when in the storage disposition.

A handle is pivotally mounted to one side of the drum and the handle includes a release button and winch key. Mounted within the drum and interconnecting the handle, the release button and the winch key to the spoke is a ratchet mechanism or assembly. In order to release the spare tire for use the individual would first move the winch key from the non-cock position to the cock position thereby causing the disengagement of an internal lock from the ratchet mechanism. The individual would then press the release button fully releasing the winch and thus allowing the spoke to freely rotate resulting in the weight of the spare tire causing the cable to unwind so that the spare tire falls toward the ground. The individual would then pass the crossbar completely back through the center of the spare tire thereby removing the spare tire from the cable and the crossbar so that the spare tire is usable. The individual can then rotate the handle clockwise to rewind the cable back on the spoke of the drum thereby lifting the crossbar in the process. The winch key can be turned to the non-cock position after the cable is coiled back on the spoke of the drum.

It is an objective of the present invention to provide a quick release apparatus for a spare tire that includes a mechanism for raising and lowering an exterior mounted spare tire.

It is another objective of the present invention to provide a quick release apparatus for a spare tire that makes tire changing faster and easier without having to locate extra tools.

It is yet another objective of the present invention to provide a quick release apparatus for a spare tire that is safer to use than traditional spare tire and jack assemblies.

These and other objects, features, and advantages will become apparent to those skilled in the art upon a perusal of the following detailed description read in conjunction with the accompanying drawing figures and appended claims.

### BRIEF DESCRIPTION OF THE DRAWINGS

FIG. 1 is a perspective view of the quick release apparatus of the present invention illustrating the mounting of the apparatus to the bumper and adjacent the undercarriage at the rear of the automotive vehicle, and the disposition of the spare tire relative to the undercarriage of the vehicle;

FIG. 2 is a side elevational view of the quick release apparatus of the present invention illustrating the disposition of the apparatus when the apparatus is in the non-use state and the spare tire is raised and located subjacent the vehicle undercarriage;

FIG. 3 is a side elevational view of the quick release apparatus of the present invention illustrating the disposition of the apparatus when the apparatus is in the use state with the spare tire being lowered for removal;

FIG. 4 is an enlarged sectioned side elevational view of the quick release apparatus of the present invention illustrating the disposition of that portion of the cable that extends through the cable conduit, and the drum that encloses therein that portion of the cable that is wound upon the spoke;

FIG. 5 is a perspective view of the quick release apparatus of the present invention illustrating the mounting of the spare tire to the end of the cable and the disposition of the cross bar for holding the spare tire in position beneath the vehicle undercarriage;

FIG. 6 is a side elevational view of the quick release apparatus of the present invention illustrating components of the apparatus that actuate the lowering of the spare tire and rewinding of the cable; and

FIG. 7 is a schematic view of the quick release apparatus of the present invention illustrating the sequence of steps undertaken to lower the spare tire.

### DETAILED DESCRIPTION OF THE PREFERRED EMBODIMENT

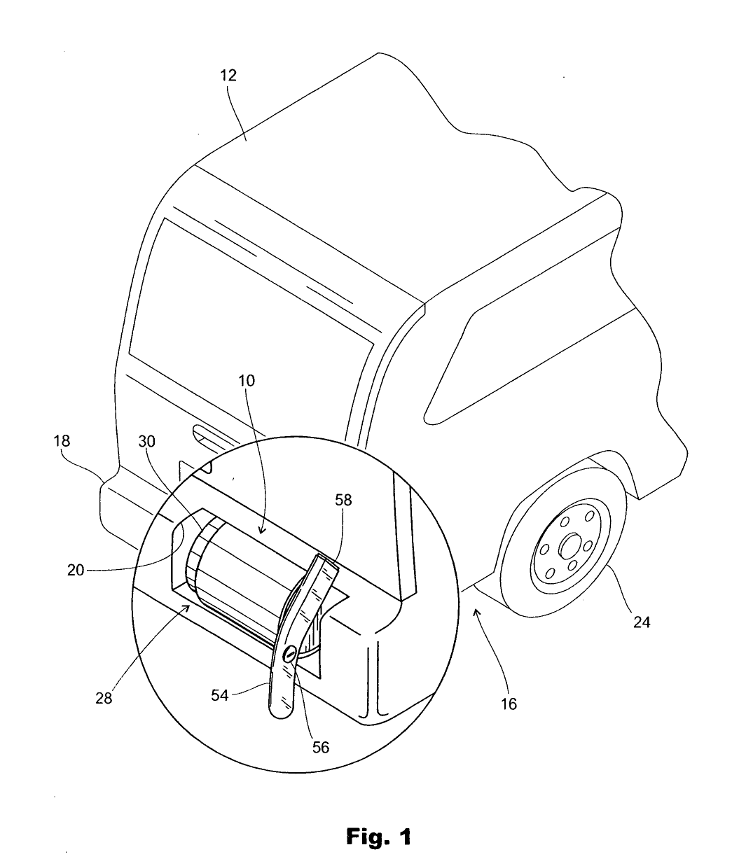

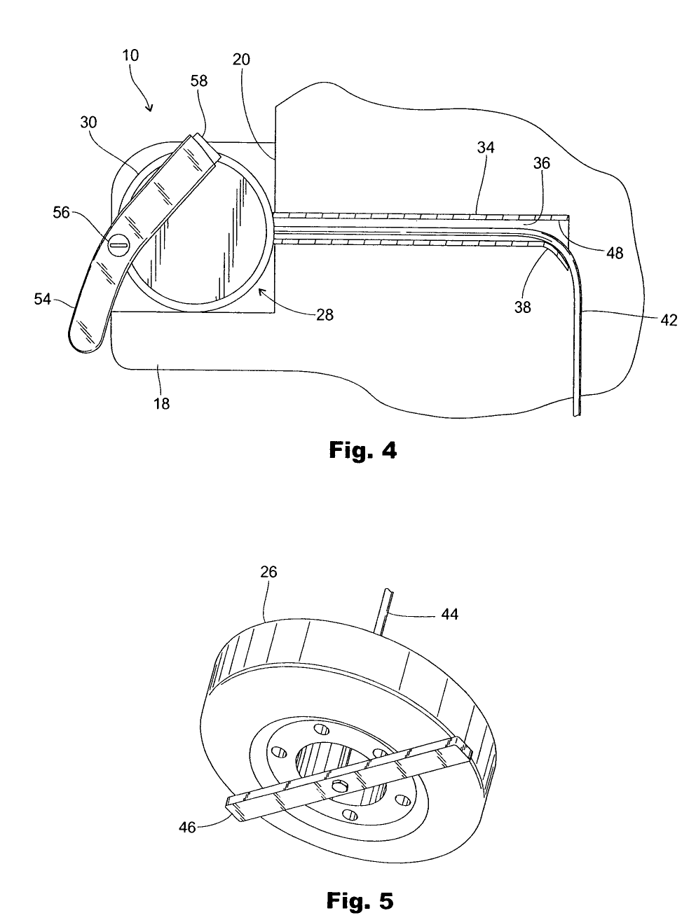

Illustrated in FIGS. 1-7 is a quick release device or apparatus 10 for easily and quickly releasing a spare tire from an automotive vehicle. The spare tire quick release apparatus 10 of the present invention is preferably mounted on or partially within a recess or cutout of a rear bumper of an automotive vehicle such as the representative automotive vehicle 12 shown in FIG. 1 (a typical SUV). The spare tire quick release apparatus 10 can also be adapted for a range of vehicles including regular two door and four door vehicles, SUVs, minivans, pickup trucks, buses, and even commercial transport and hauling trucks.

Thus, as shown in FIGS. 1-5, the automotive vehicle 12 includes a front 14, a rear 16, a rear bumper 18 having a centrally located recess or cut-out 20 for supporting thereon the spare tire quick release apparatus 10, and an underside or undercarriage 22. In addition, the vehicle 10 includes a pair of front wheels and a pair of rear wheels (tires) 24 with only the rear wheels 24 being shown. The spare tire quick release apparatus 10 is mounted on or within the rear bumper 18 with elements of the apparatus 10, including a spare tire 26, disposed immediately beneath or subjacent the undercarriage 22 and behind the rear wheels 24.

The spare tire quick release apparatus 10 includes a winch assembly 28 that is centrally mounted to or upon the rear bumper 18. The winch assembly 28 includes a cylindrical drum 30 fixedly mounted to the rear bumper 18. The drum 30 includes an interior cavity 32, and laterally extending from the drum 30 towards the front 14 of the vehicle 12 is a cable tube or conduit 34. The cable tube 34 includes a passageway 36 coequal in length with the cable tube 34, and the cable tube 34 terminates with a downwardly rolled or arcuate lip 38. The cable tube 34 registers with the cavity 32 of the drum 30 at its inner end.

As shown in FIGS. 1-7, a spoke 40 is rotatably mounted within the drum 30 and extends transversely through the drum 30. Wound and coiled on the spoke 40 is a cable 42, preferably a flexible steel cable having a diameter of at least three inches. The cable 42 extends through the cable tube 34 and past the rolled lip 38 terminating at a distal cable end 44. The rolled lip 38 of the cable tube 34 protects the cable 42 during the raising and lowering of the cable 42. Attached to the distal cable end 44 is a crossbar 46, and as shown in FIG. 5, the crossbar 46 is secured to the tip of the distal end 44 of the cable 42 by a nut and bolt arrangement. The spare tire 26 is supported on the crossbar 46 with the distal end 44 of the cable 42 extending through the center of the spare tire 26. The spare tire 26 is located at the rear 16 of the vehicle 12 immediately subjacent the undercarriage 22 of the vehicle 12 and behind the rear axle and rear wheels 24. The spare tire 26 is located immediately beneath the undercarriage 22 and adjacent to the rolled lip 38 and end opening 48 of the cable tube 34 to minimize any movement—swinging or swaying back and forth—of the spare tire 26 during vehicle operation.

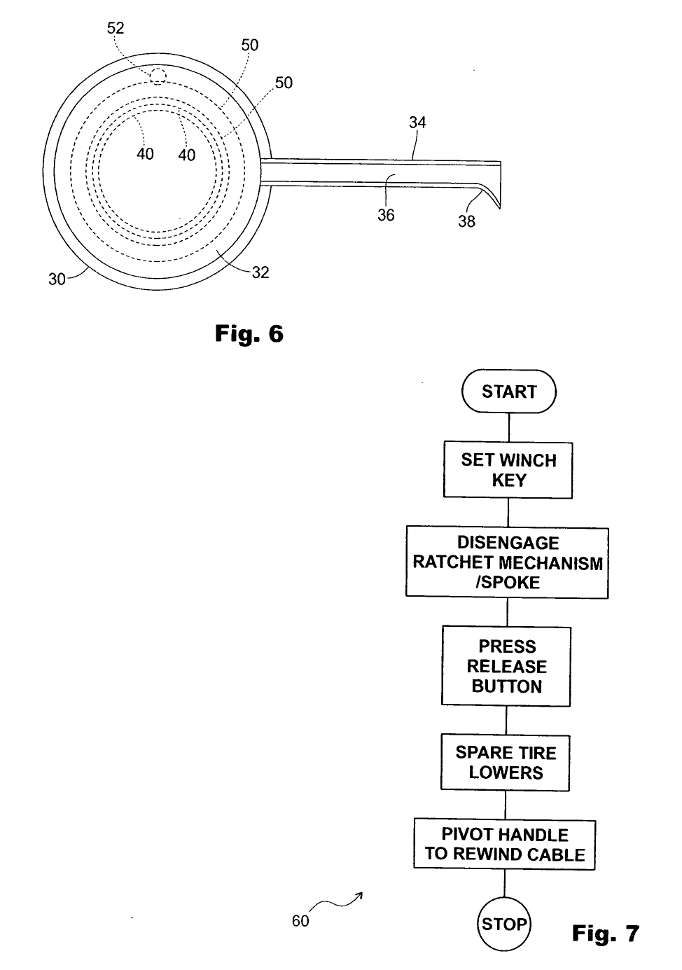

As illustrated in FIG. 6, a ratchet mechanism 50 is disposed within the interior cavity 32 of the drum 30 and is located adjacent one side of the drum 30. The ratchet mechanism 50 allows the spoke 40 to freely rotate in one direction for unwinding the cable 42 and lowering the spare tire 26, but engages the spoke 40 when the spoke 40 is rotated in the opposite direction for rewinding and coiling the cable 42 back on the spoke 40. A lock 52 is also mounted within the drum 30 and is capable of engagement to and disengagement from the ratchet mechanism 50 and the spoke 40 in order to prevent rotation of the spoke 40 or allow spoke 40 rotation. Mounted on one side of the drum 30 of the winch assembly 28 is a handle 54, and the handle 54 is pivotally mounted to the drum 30 through a winch key 56 so that the handle 54 can move or be pivoted clockwise and counterclockwise for reeling in the cable 42 or to facilitate the unwinding of the cable 42. The winch key 56 can be turned and set between two different positions: a non-cock position and a cock position. When the winch key 56 is set to the non-cock position, the cable 42 can't be released and the spare tire 26 is maintained in its storage position; when the winch key 56 is set to the cock position the spoke 40 is disengaged and able to rotate thereby allowing the cable 42 to unwind for lowering the spare tire 26. The handle 54 also includes a release button 58 that is interconnected to the spoke 40 through the winch key 56. The release button 58 is prevented from being pressed when the winch key 56 is set in the non-cock position.

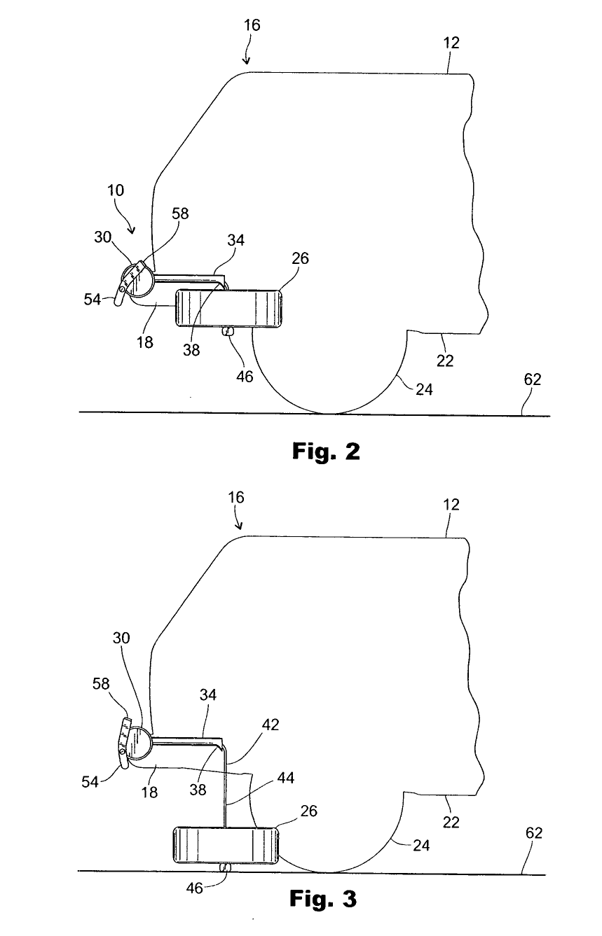

With reference to FIG. 7, the operational steps or processes for operating the spare tire quick release apparatus 10 are set forth in schematic diagram or operational flow-chart 60. After the driver has situated the vehicle 12 in a safe position—or as safe a location as possible given that need to replace or change a tire can occur at any time or place—the individual would then carefully walk to the rear 16 of the vehicle 12 to start or initiate the lowering of the spare tire 26 by first setting the winch key 56 from non-cock position to the cock position. The button release 58 is prevented from being pushed when the winch key 56 is set in the non-cock position. Setting the winch key 56 to the cock position causes the lock 52 to be pushed out for disengaging the ratchet mechanism 50. The individual then presses the release button 58 on the handle 54 and immediately the spoke 40 rotates, and the weight of the spare tire 26 causes the cable 42 to unwind so that the spare tire 26 is lowered to a position just above the ground surface 62 as shown in FIG. 3. The spare tire 26 is then maneuvered so that the crossbar 46 can be passed back through the open center or aperture 64 of the spare tire 26 to completely remove the spare tire 26 from the cable 42. Finally, the individual can set the winch key 56 back to the non-cock position and rotate the handle 54 clockwise to rotate the spoke 40 and reel the cable 42 back onto the spoke 40, and back to the position shown in FIG. 2 (absent the spare tire 26).

A preferred embodiment of the invention is disclosed herein, and it should be understood that numerous modifications, alterations, and variations are possible and practicable to those skilled in the art while still coming within the spirit and scope of the invention as set forth in the above description and appended claims.

I claim:

1. A quick release apparatus for releasing a spare tire mounted to the underside of an automotive vehicle and located the rear of the automotive vehicle, comprising:
a winch assembly mounted at the rear of the automotive vehicle;
the winch assembly including a drum;
a spoke rotatably mounted within the drum;
a cable tube connected to the drum and extending toward the front of the automotive vehicle;
a handle pivotally mounted to the drum for selectively releasing the spare tire;
a winch key mounted to the handle and which can be set between a non-cock position and a cock position;
a release button mounted to the handle and which must be pressed for actuating the release and lowering of the spare tire;
a flexible cable wound on the spoke and extending through the cable tube and the cable terminating at a distal cable end;
a crossbar secured to the distal cable end of the cable for supporting the spare tire subjacent the underside of the automotive vehicle; and
whereupon setting the winch key to the cock position and then pressing the release button permits the cable to unwind and lower the spare tire for removal and use and then rotating the handle in the clockwise direction causes the cable to rewind.

2. A quick release apparatus for releasing a spare tire mounted to the underside of an automotive vehicle with the quick release apparatus and the spare tire located at the rear of the automotive vehicle, comprising:
a drum mounted at the rear of the automotive vehicle;
a cable tube connected to the drum and projecting toward the front of the automotive vehicle;
a flexible cable rotatably disposed within the drum and extending through the cable tube with the cable terminating at a distal cable end;
a crossbar secured to the distal cable end for supporting the spare tire thereon;
a handle pivotally mounted to the drum;
a release button mounted to the handle; and
whereupon pressing the release button on the handle actuates the lowering of the spare tire for removal and use and then pivoting the handle in the clockwise direction causes the cable to rewind back through the cable tube and within the drum.
